(19) United States
(12) Patent Application Publication
(10) Pub. No.: US 2025/0300791 A1
(43) Pub. Date: Sep. 25, 2025

(54) COEXISTENCE OF UWB AND OTHER TRANSMISSIONS

(71) Applicant: QUALCOMM INCORPORATED, San Diego, CA (US)

(72) Inventors: Varun Amar REDDY, San Diego, CA (US); Aleksandar DAMNJANOVIC, Del Mar, CA (US); Krishna Kiran MUKKAVILLI, San Diego, CA (US)

(21) Appl. No.: 18/609,864

(22) Filed: Mar. 19, 2024

(51) Int. Cl. H04L 5/00; H04W 72/0453

(52) U.S. Cl. CPC H04L 5/0073; H04L 5/0048; H04W 72/0453

(57) ABSTRACT

A method of scheduling a UWB (Ultra-Wideband) ranging session includes: obtaining a first signal transmission schedule of first available signal transmission times of first wireless signals; and transmitting, from a first UWB device to a second UWB device, a ranging control message indicating a second signal transmission schedule including second available signal transmission times for second wireless signals that comprise UWB signals, wherein the second available signal transmission times are based on the first available signal transmission times.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Sixth generation (6G) networks are expected to be significantly faster than previous network generations, more diverse than previous network generations, and able to support new applications. It is expected that 6G networks will operate in frequency bands used by other applications, e.g., Ultra-Wideband (UWB) applications for communication in a 3.1 GHz to 10.6 GHz frequency spectrum. For instance, a comprehensive specification of UWB applications can be found, for instance, in IEEE Std. 802.15.4z-2020 discussing Enhanced Ultra Wideband (UWB) Physical Layers (PHYs) and Associated Ranging Techniques.

### SUMMARY

An example method of scheduling a UWB (Ultra-Wideband) ranging session includes: obtaining a first signal transmission schedule of first available signal transmission times of first wireless signals; and transmitting, from a first UWB device to a second UWB device, a ranging control message indicating a second signal transmission schedule including second available signal transmission times for second wireless signals that comprise UWB signals, wherein the second available signal transmission times are based on the first available signal transmission times.

An example first UWB device includes: at least one transceiver configured to transmit and receive UWB signals; at least one memory; and at least one processor, communicatively coupled to the at least one transceiver and the at least one memory, configured to: obtain a first signal transmission schedule of first available signal transmission times of first wireless signals; and transmit, via the at least one transceiver to a second UWB device, a ranging control message indicating a second signal transmission schedule including second available signal transmission times for second wireless signals that comprise UWB signals, wherein the second available signal transmission times are based on the first available signal transmission times.

Another example first UWB device includes: means for obtaining a first signal transmission schedule of first available signal transmission times of first wireless signals; and means transmitting, to a second UWB device, a ranging control message indicating a second signal transmission schedule including second available signal transmission times for second wireless signals that comprise UWB signals, wherein the second available signal transmission times are based on the first available signal transmission times.

An example non-transitory, processor-readable storage medium includes processor-readable instructions to cause at least one processor of a first UWB device to: obtain a first signal transmission schedule of first available signal transmission times of first wireless signals; and transmit, to a second UWB device, a ranging control message indicating a second signal transmission schedule including second available signal transmission times for second wireless signals that comprise UWB signals, wherein the second available signal transmission times are based on the first available signal transmission times.

An example method of scheduling wireless signaling device signal transmissions includes: obtaining, at a wireless signaling device, a second signal transmission schedule of second available signal transmission times of second wireless signals, the second wireless signals being UWB signals of a UWB ranging session between a first UWB device and a second UWB device; and transmitting, from the wireless signaling device to the first UWB device and based on the second signal transmission schedule, a first signal transmission schedule of first available signal transmission times for first wireless signal transmissions.

An example wireless signaling device includes: at least one transceiver; at least one memory; and at least one processor, communicatively coupled to the at least one transceiver and the at least one memory, configured to: obtain a second signal transmission schedule of second available signal transmission times of second wireless signals, the second wireless signals being UWB signals of a UWB ranging session between a first UWB device and a second UWB device; and transmit, via the at least one transceiver to the first UWB device and based on the second signal transmission schedule, a first signal transmission schedule of first available signal transmission times for first wireless signal transmissions.

Another example wireless signaling device includes: means for obtaining a second signal transmission schedule of second available signal transmission times of second wireless signals, the second wireless signals being UWB signals of a UWB ranging session between a first UWB device and a second UWB device; and means for transmitting, to the first UWB device and based on the second signal transmission schedule, a first signal transmission schedule of first available signal transmission times for first wireless signal transmissions.

Another example non-transitory, processor-readable storage medium includes processor-readable instructions to cause at least one processor of a wireless signaling device to: obtain a second signal transmission schedule of second available signal transmission times of second wireless signals, the second wireless signals being UWB signals of a UWB ranging session between a first UWB device and a second UWB device; and transmit, to the first UWB device and based on the second signal transmission schedule, a first signal transmission schedule of first available signal transmission times for first wireless signal transmissions.

### BRIEF DESCRIPTION OF THE DRAWINGS

FIG. 1 is a diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a block diagram of an example user equipment.

FIG. 6 is a block diagram of an example network entity.

FIG. 7 is a communication environment including a base station, and multiple user equipments.

FIG. 8A is a timing diagram of a processing and signal flow of a ranging session.

FIG. 8B is a timing diagram of another processing and signal flow of a ranging session.

FIG. 9 is a block diagram of a portion of an Ultra-Wideband (UWB) ranging block.

FIG. 10 is a timing diagram of a ranging round within the UWB ranging block shown in FIG. 9.

FIG. 11 is a timing diagram of a processing and signal flow for scheduling a UWB session relative to a network session.

FIG. 12 is a block diagram of a time relationship between a UWB ranging block and a network communication frame.

FIG. 13 is a timing diagram of a processing and signal flow for scheduling a network session relative to a UWB session.

FIG. 14 is a timing diagram of a processing and signal flow for scheduling one or more network sessions relative to multiple UWB sessions.

FIG. 15 is a block flow diagram of a method of scheduling a UWB ranging session.

FIG. 16 is a block flow diagram of a method of scheduling network signal transmissions.

### DETAILED DESCRIPTION

Techniques are discussed herein for facilitating UWB (Ultra-Wideband) signal transmissions as part of a UWB session between user equipments (UEs) while avoiding (e.g., partially or completely) interference from one or more wireless signal transmissions, e.g., of a same frequency as the UWB signal transmissions. For example, a wireless signaling device (e.g., a network entity, another UE (e.g., a UWB device)) may produce a first signal transmission schedule and a UE may obtain (e.g., receive and/or learn) the first signal transmission schedule and determine a second signal transmission schedule (that is a UWB signal transmission schedule) to avoid transmission overlap (e.g., in time and frequency (directly or due to a harmonic)) with the first signal transmission schedule. The wireless signaling device may determine the first signal transmission schedule based on receiving UWB schedule information from the UE, e.g., the second signal transmission schedule. As another example, a wireless signaling device may receive UWB schedule information from one or more UEs for one or more second signal transmission schedules, determine one or more first signal transmission schedules in order to avoid overlap with the second signal transmission schedule(s), and transmit the first signal transmission schedule(s) to the UE(s). The UE(s) obtaining (e.g., receiving and/or learning) the first signal transmission schedule may or may not alter a respective UWB schedule based on the first signal transmission schedule. Other implementations, however, may be used.

Items and/or techniques described herein may provide one or more of the following capabilities, as well as other capabilities not mentioned. UWB sessions may be conducted in the presence of one or more other signaling sessions while avoiding interference between the UWB and the other signaling session(s). Success rate of UWB signal transfer (e.g., unlocking vehicles by a UE) within range of other signal transmissions may be improved. Cellular network sessions can boost coverage and capacity for UEs, e.g., by operating over unlicensed bands without hampering UWB performance. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. In industrial applications, the location of a mobile device may be necessary for asset tracking, robotic control, and other kinematic operations which may require a precise location of an end effector. Existing positioning methods include methods based on measuring radio signals transmitted from a variety of devices or entities including satellite vehicles (SVs) and terrestrial radio sources in a wireless network such as base stations and access points. Stations in a wireless network may be configured to transmit reference signals to enable mobile device to perform positioning measurements.

Positioning measurements may be used for various positioning methods, which may utilize reference signals transmitted by base stations in a manner similar to which LTE wireless networks utilize Positioning Reference Signals (PRS) and/or Cell-specific Reference Signals (CRS) for position determination.

Other positioning methods for obtaining the locations of mobile devices (e.g., UWB devices) include single-sided two-way ranging (SS-TWR), double-sided two-way ranging (DS-TWR), or one-way ranging (OWR) for a time difference of arrival (TDOA) localization method. For example, SS-TWR involves a measurement of the round-trip delay of a single message from one device to another and a response sent back to the original device. DS-TWR is an extension of SS-TWR in which two round-trip time measurements are used and combined to give the TOF (Time Of Flight) result with a reduced error in the presence of uncorrected clock frequency offset. TDOA is a technique to locate a mobile device, (e.g., a radio frequency identification (RFID) device), based on the relative arrival times of a single message or multiple messages. OWR is used for TDOA and there are two cases of TDOA. In a first TDOA case, a message is periodically broadcast by the mobile device to multiple fixed nodes that are synchronized in some way so that the arrival times can be compared. Typically, the message sent by the mobile device is referred to as a blink. In a second TDOA case, multiple synchronized nodes broadcast messages sequentially with known transmission time offsets with respect to each other. For any pair of fixed synchronized nodes, the difference in arrival time of the blink in the first case, or the broadcast messages at the mobile device in the second case, places the mobile device on a hyperbolic surface. Combining the results from multiple such pairs will yield an intersection point between the sets of hyperbolic surfaces yielding the location of the mobile device. In the second case, the transmission offset is taken into account when calculating the difference in arrival time of messages from synchronized nodes.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit boards (PCBs), compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

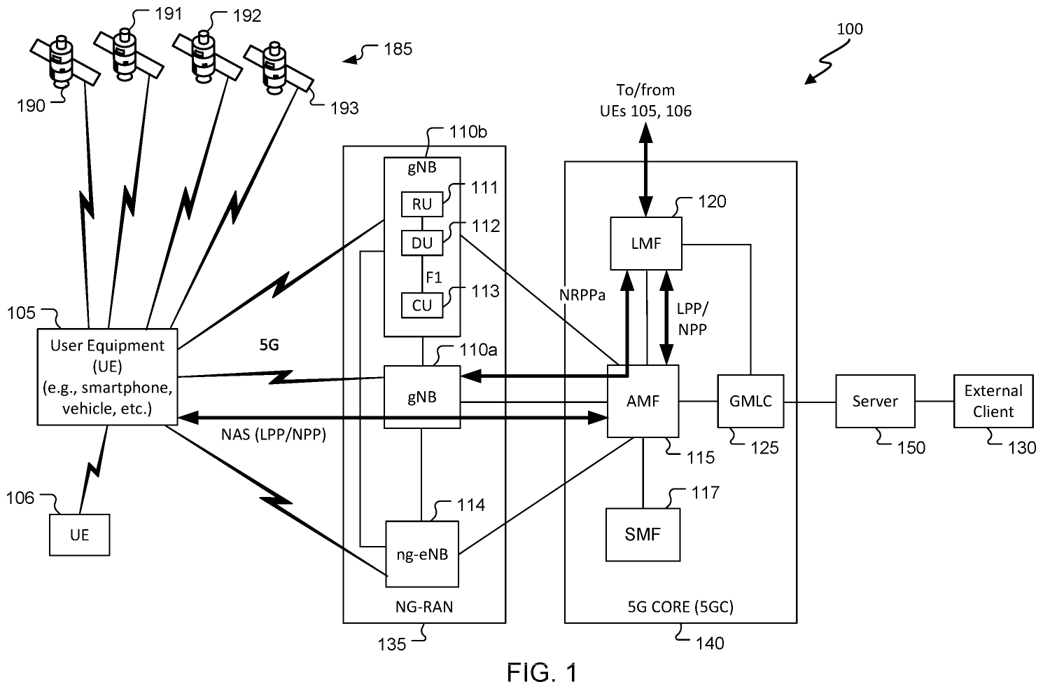

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110_{b}) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110_{a,} 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

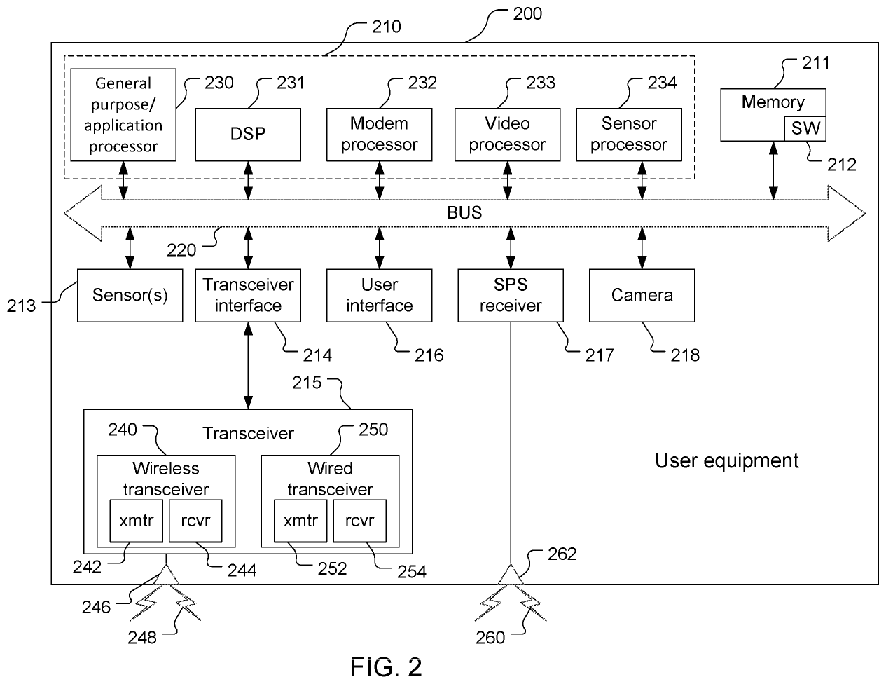

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, and a camera 218. The processor 210, the memory 211, the sensor(s) 213, the transceiver interface 214, the user interface 216, the SPS receiver 217, and the camera 218 may be communicatively coupled to each other by a bus 220 (which may be configured, e.g., for optical and/or electrical communication). One or more of the shown apparatus (e.g., the camera 218, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, and/or a wired transceiver. The sensor(s) 213 may include one or more motion sensors (e.g., one or more inertial sensors) and/or one or more environmental sensors.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

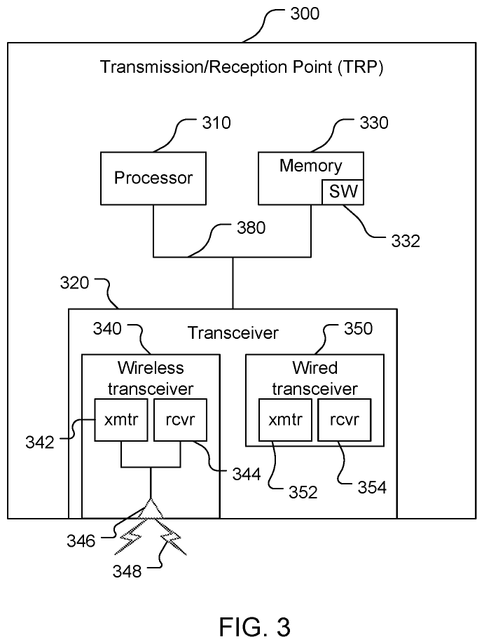

Referring also to FIG. 3, an example of a TRP 300 of the gNBs 110a, 110b and/or the ng-eNB 114 may comprise a computing platform including a processor 310, memory 330 including software (SW) 332, and a transceiver 320. Even if referred to in the singular, the processor 310 may include one or more processors, the transceiver 320 may include one or more transceivers (e.g., one or more transmitters and/or one or more receivers), and the memory 330 may include one or more memories. The processor 310, the memory 330, and the transceiver 320 may be communicatively coupled to each other by a bus 380 (which may be configured, e.g., for optical and/or electrical communication). One or more of the shown apparatus may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 330 may be a non-transitory storage medium that may include random access memory (RAM)), flash memory, disc memory, and/or read-only memory (ROM), etc. The memory 330 may store the software 332 which may be processor-readable, processor-executable software code containing instructions that are configured to, when executed, cause the processor 310 to perform various functions described herein. Alternatively, the software 332 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 330) of the TRP 300 (and thus of one of the gNBs 110a, 110b and/or the ng-eNB 114) performing the function. The processor 310 may include a memory with stored instructions in addition to and/or instead of the memory 330. Functionality of the processor 310 is discussed more fully below.

The transceiver 320 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

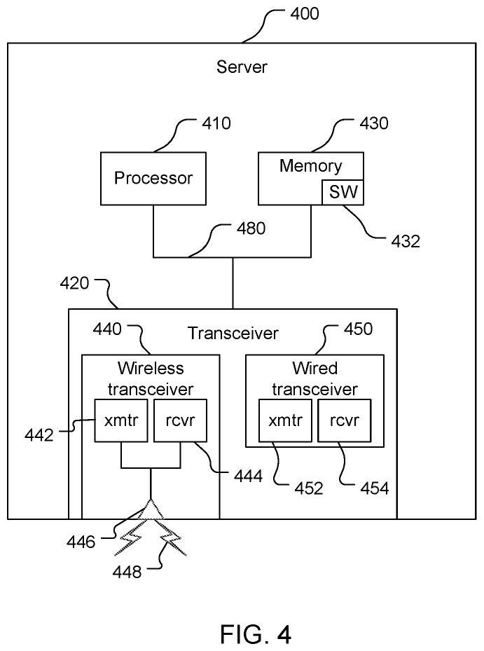

Referring also to FIG. 4, a server 400, of which the LMF 120 may be an example, may comprise a computing platform including a processor 410, memory 430 including software (SW) 432, and a transceiver 420. Even if referred to in the singular, the processor 410 may include one or more processors, the transceiver 420 may include one or more transceivers (e.g., one or more transmitters and/or one or more receivers), and the memory 430 may include one or more memories. The processor 410, the memory 430, and the transceiver 420 may be communicatively coupled to each other by a bus 480 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 430 may be a non-transitory storage medium that may include random access memory (RAM)), flash memory, disc memory, and/or read-only memory (ROM), etc. The memory 430 may store the software 432 which may be processor-readable, processor-executable software code containing instructions that are configured to, when executed, cause the processor 410 to perform various functions described herein. Alternatively, the software 432 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 430. Functionality of the processor 410 is discussed more fully below.

The transceiver 420 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee®, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

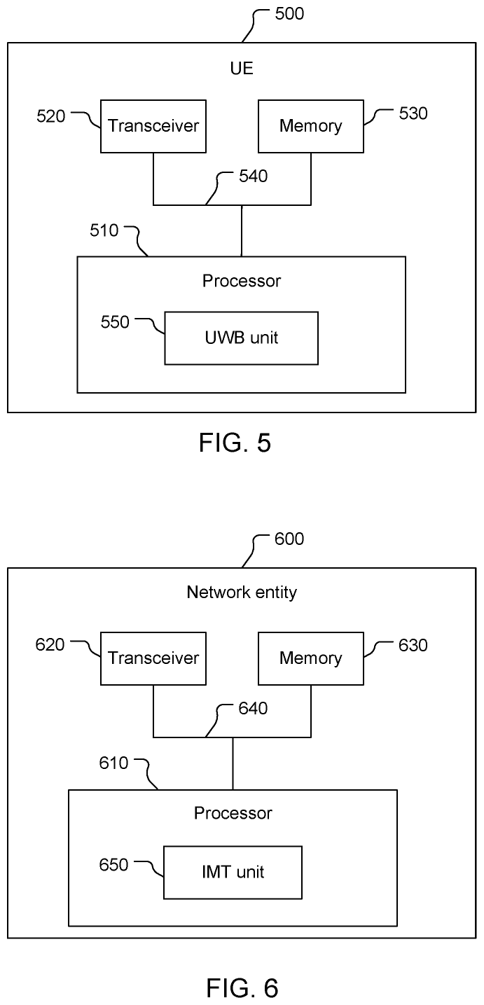

Referring also to FIG. 5, a UE 500 includes a processor 510, a transceiver 520, and a memory 530 communicatively coupled to each other by a bus 540. Even if referred to in the singular, the processor 510 may include one or more processors, the transceiver 520 may include one or more transceivers (e.g., one or more transmitters and/or one or more receivers), and the memory 530 may include one or more memories. The UE 500 may include the components shown in FIG. 5. The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include a UWB unit 550. The UWB unit 550 may be configured to establish a UWB ranging session and may be configured to provide UWB schedule information, e.g., as part of a request for RAT (e.g., IMT (International Mobile Telecommunications)) signal scheduling. The UWB unit 550 is discussed further below, and the description may refer to the processor 510 generally, or the UE 500 generally, as performing any of the functions of the UWB unit 550, with the UE 500 being configured to perform the function(s).

Referring also to FIG. 6, a network entity 600 includes a processor 610, a transceiver 620, and a memory 630 communicatively coupled to each other by a bus 640. Even if referred to in the singular, the network entity 600 may include one or more network entities, the processor 610 may include one or more processors, the transceiver 620 may include one or more transceivers (e.g., one or more transmitters and/or one or more receivers), and the memory 630 may include one or more memories. The network entity 600 may include the components shown in FIG. 6 and may be configured to be a component of a communication network (e.g., a terrestrial communication network such as a cellular network). The network entity 600 may include one or more other components such as any of those shown in FIG. 4 such that the server 400 may be an example of the network entity 600. For example, the processor 610 may include one or more of the components of the processor 410. The transceiver 620 may include one or more of the components of the transceiver 420. The memory 630 may be configured similarly to the memory 430, e.g., including software with processor-readable instructions configured to cause the processor 610 to perform functions. Also or alternatively, the network entity 600 may include one or more other components such as any of those shown in FIG. 3 such that the TRP 300 may be an example of the network entity 600. For example, the processor 610 may include one or more of the components of the processor 310. The transceiver 620 may include one or more of the components of the transceiver 320. The memory 630 may be configured similarly to the memory 330, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the transceiver 620) may include a RAT unit 650. The RAT unit 650 may be configured to schedule RAT signaling based on UWB scheduling information received from a UE. The RAT unit 650 is discussed further below, and the description may refer to the processor 610 generally, or the network entity 600 generally, as performing any of the functions of the RAT unit 650, with the network entity 600 being configured to perform the function(s).

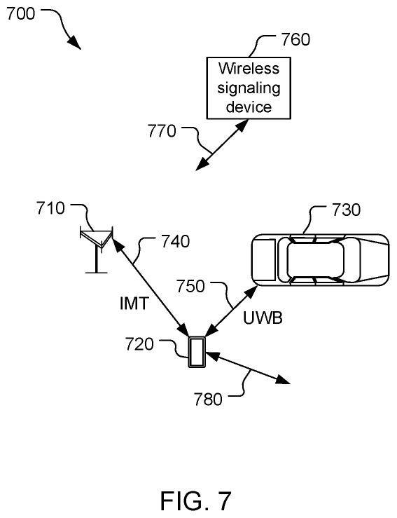

Referring also to FIG. 7, a signaling environment 700 includes a base station 710, and UEs 720, 730. Each of the UEs 720, 730 may be an example of the UE 500. In this example, the UE 720 is a smart phone and the UE 730 is a vehicle, or at least a portion thereof. The base station 710 may include one or more of the TRPs 300 and may be configured to provide RAT signals, e.g., may serve as a base station of a cellular network. The UE 720 may be configured to communicate with the base station 710 through RAT signaling, e.g., the transfer (e.g., exchange) of RAT signals 740. The UE 720 may obtain (e.g., receive from the base station 710 and/or learn) a first signal transmission schedule (e.g., a RAT transmission schedule). A RAT schedule (which may be called a RAT transmission schedule) may include indications of timing of RAT frames, subframes within respective frames, slots within respective subframes, and symbols within respective slots. The UEs 720, 730 may be configured to communicate with each other through UWB signaling, e.g., the transfer of UWB signals 750. New spectrum may be used for next generation (e.g., 6G) RAT signals, and this new spectrum may overlap with the UWB spectrum. RAT signals that use the same spectrum as UWB devices may cause interference with UWB signals, especially because UWB signal transmit power is −14.3 dBm or less, and RAT signal transmit power may be approximately 40 dBm. Interference with UWB communications may be of concern for UWB device manufacturers, for example, vehicle manufacturers that have urged 99.9% success rate for digital car key functionality (e.g., unlocking, locking, starting, and/or shutting off a vehicle) using UWB signaling. To help achieve 99.9% success rate, the UWB unit 550 and/or the RAT unit 650 may help mitigate or avoid interference between RAT signals (e.g., FR3 signals with a frequency between 7.125 GHz and 24.25 GHZ) and UWB signals (signals with a frequency between 3.1 GHz and 10.6 GHz). To help mitigate or avoid such interference, the UWB unit 550 and the RAT unit 650 may implement one or more coexistence techniques. The UE 720 may be connected to a RAT network and/or may serve as a UWB controller. The signaling environment 700 may include a wireless communication device 760 (and possibly one or more other wireless signaling devices) in addition to or instead of the base station 710. The wireless signaling device may be configured to transfer (e.g., transmit and/or receive) signals 770 (e.g., RAT signals (e.g., SL signals), and/or UWB signals, etc.) that may interfere with one or more signals received by the UE 720. Also or alternatively, the UE 720 may transmit signals 780 (e.g., one or more of the RAT signals 740, and/or one or more other UWB signals, etc.) that may interfere with the UWB signals 750.

UWB devices may use pulse-based radio signaling (e.g. short-pulse-UWB) instead of OFDM-based signaling (Multi-Band OFDM UWB (MB-OFDM-UWB)). Short-pulse-UWB signaling transmits with the energy for each bit spread over the entire UWB channel bandwidth (e.g., 1.37 GHz, 4 GHZ, etc.) with varying pulse amplitude and/or pulse polarity without using an RF carrier, while MB-OFDM-UWB transmits each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various pulse shapes (e.g. Gaussian pulses, Monocycle pulses, Hermite pulses, etc.) and the shape used may be chosen based on pulse properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high-speed Analog-to-Digital converter (ADC) and a high-speed Digital-to-Analog Converter (DAC) to be able to handle the very wide frequency band used; however, there may be other ways to handle ultra-fast sampling such as using Time Hopping techniques, Direct Sequence coding techniques, etc.

Multi-Band OFDM UWB divides up spectrum into several frequency sub-bands and OFDM is applied within each band; whereas other OFDM systems typically operate within a fixed frequency band. The complex waveform created by combining the multiple-sub-bands results in a final waveform that is used for transmission for MB-OFDM-UWB. Multi-Band OFDM UWB also differs from other OFDM systems by not using a guard interval, by using simpler modulation schemes like Binary Phase Shift keying (BPSK) or Quadrature phase-shift keying (QPSK) versus 64 or 256 Quadrature Amplitude Modulation (QAM), by using a constant power level whereas other OFDM systems may use power control for varying channel conditions, etc.

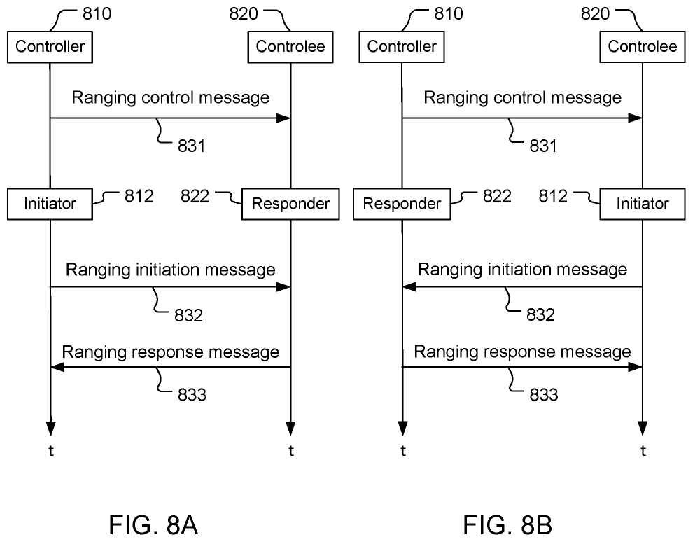

Referring also to FIGS. 8A and 8B, a UWB device may be a controller or a controlee, and may be an initiator or a responder. A UWB device is a device, such as a UE, that is configured to communicate with another UWB device using UWB signals. A UWB controller (which may be referred to herein as a controller) is an Enhanced Ranging Device (ERDEV) that is configured to control a UWB ranging session, to define ranging parameters, and to provide the ranging parameters to another UWB device by sending a Ranging Control Message (RCM). The RCM may be sent over a UWB link and/or over another communication link (e.g., a WiFi or NR (New Radio)). The RCM contains metrics (e.g., selected channel, transmit power, timing information) for how a UWB session will function. The controller may be configured to update ranging parameters during an ongoing session by sending a Ranging Control Update Message (RCUM), e.g., periodically. A UWB controlee (which may be referred to herein as a controlee) is an ERDEV that is configured to use the ranging parameters received from the controller in the RCM or RCUM in order to transmit and/or receive UWB ranging messages. An initiator is an ERDEV that uses information from the RCM to initiate a ranging transfer by sending a Ranging Initiation Message (RIM) to a responder. A controller or a controlee may be an initiator or a responder. A responder is an ERDEV that responds to the RIM received from the initiator by sending a Ranging Response Message (RRM) to the initiator. The RIM and/or RRM may be measured for positioning, e.g., to determine a time of arrival (ToA) estimate and/or an angle of arrival (AoA) estimate, etc. The initiator and responder provide two-way ranging, which can correct clock offset errors between the initiator and the responder, which may improve the accuracy of a ToA estimate and the accuracy of an overall range (and thus position) estimate. For example, as shown in FIG. 8A, a controller 810 sends an RCM 831 to a controlee 820. The controller 810, acting as an initiator 812, sends an RIM 832 to the controlee 820, that is acting as a responder 822. The responder 822 responds to the RIM 832 by sending an RRM 833 to the initiator 812. As another example, as shown in FIG. 8B, the controller 810 sends the RCM 831 to the controlee 820. The controlee 820, acting as the initiator 812, sends the RIM 832 to the controller 810, that is acting as the responder 822. The responder 822 responds to the RIM 832 by sending the RRM 833 to the initiator 812.

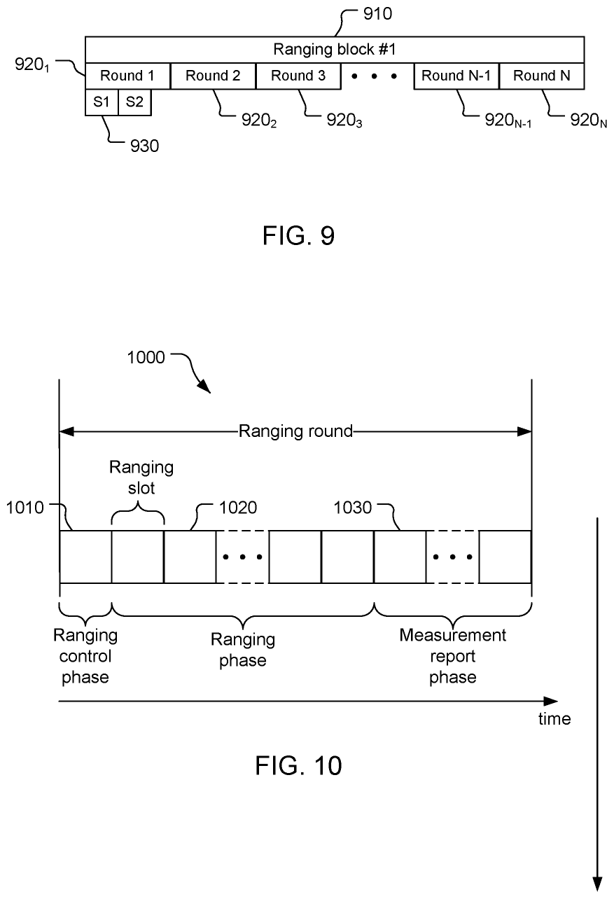

Referring also to FIG. 9, a UWB session comprises consecutive ranging blocks, which are blocks of time. Each ranging block, such as a ranging block 910, may have a duration between 200 ms and 250 ms. Each ranging block includes multiple rounds, e.g., rounds 920₁, 920₂, 920₃, . . . , 920_{N-1}, 920_{N}, with each round being between 10 ms and 20 ms. Each of the rounds 920₁-920_{N} includes ranging slots 930, with each of the slots 930 being between 1 ms and 2.66 ms in duration. A ranging packet within a slot may have an SP3 format (akin to a PRS) and may have a duration up to 1 ms, e.g., a duration of about 150 μs, while a remainder of the slot may be retained for processing delays. The quantity N of the rounds 920₁-920_{N} within the ranging block 910 may be configured by the UWB controller, e.g., the controller 810. Transmissions for any given ranging block occur within a selected one of the rounds, with no transmissions being sent by either UWB device of the session during the other (non-selected) rounds. The selected round for any particular ranging block may be statically configured in the RCM by the controller, or may be selected per a hopping pattern. The hopping pattern may be a formula that is known by the initiator and the responder, and the initiator and the responder may apply the formula independently to send and receive ranging messages. The round structure and the selection of a round may be used to help avoid interference between UWB sessions because multiple UWB sessions may exist in close proximity to each other, without any central control of the multiple sessions.

Referring also to FIG. 10, a ranging round 1000 is divided into slots that may be used for various purposes. For example, a first slot 1010 may be for a ranging control phase and thus reserved for transferring the RCM. A set of slots 1020 is assigned to a ranging phase and used by the initiator and the responder to transfer, in alternating slots, the RIM and the RRM, respectively. Multiple RIMs and RRMs may be transferred in order to achieve a desired result (e.g., one or more measurements of sufficient accuracy). An optional measurement report phase may comprise slot 1030 during which the initiator and the responder may transfer measurements that can be used to calculate a range between the initiator and the responder. A RAT frame may be 10 ms in duration, and thus on the order of the duration of the ranging round 1000 if the ranging round 1000 includes 10 slots each of about 1 ms in duration. Similarly, a RAT subframe may be 1 ms long, which is the same as a minimum duration for a UWB ranging slot.

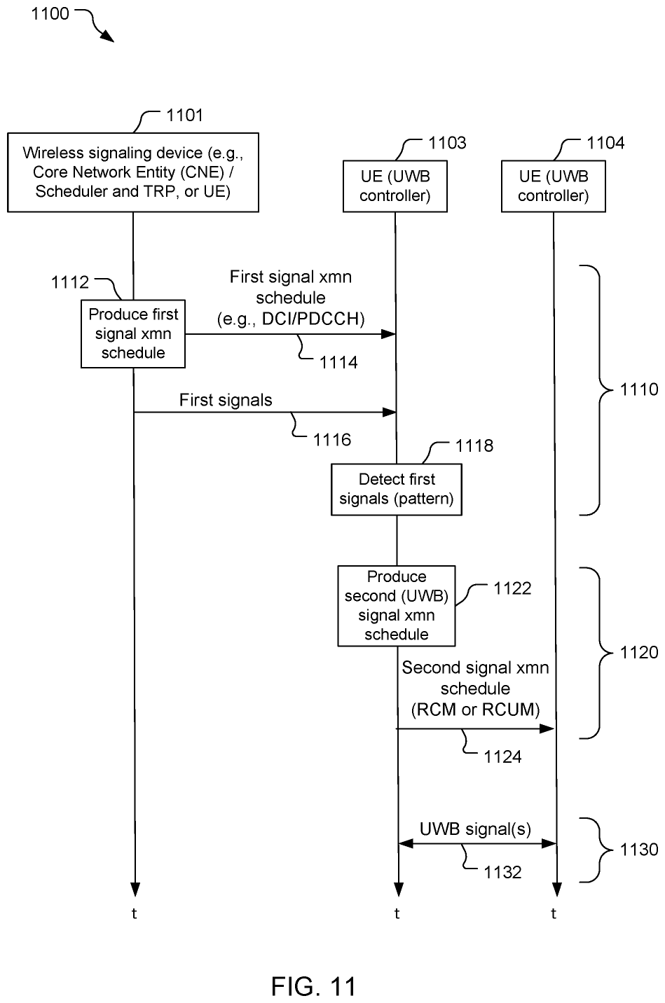

Referring also to FIG. 11, a signal and processing flow 1100 for determining and providing a UWB schedule in view of another signal transmission schedule includes stages shown. The flow 1100 is an example flow and not limiting. The flow 1100 may be altered, e.g., by having one or more messages and/or one or more stages added and/or having one or more messages and/or one or more stages split into multiple messages and/or stages. In the flow 1100, signals may be transferred among a wireless signaling device 1101, a UE 1103, and a UE 1104. The wireless signaling device 1101 may comprise, for example, a UE, or a Core Network Entity (CNE), or a TRP, or combination of a CNE and a TRP, etc. A CNE may be an example of the network entity 600. A TRP may be an example of the TRP 300. The wireless signaling device 1101 may be an example of the UE 500, or another device that can transfer (e.g., transmit and/or receive) wireless signals. The wireless signaling device 1101 may not transfer wireless signals exclusively, and may transfer wireless signals and guided (e.g., wired) signals. The wireless signaling device 1101 includes at least one radio (each radio being part of a transmitter, receiver, or transceiver) for wireless signal transfer. The UEs 1103, 1104 may be examples of the UE 500, with the UE 1103 acting as a UWB controller and the UE 1104 acting as a UWB controlee. For example, the UE 1103 may intend to initiate a UWB ranging session with a vehicle in a low-vehicle-density region (e.g., near a house in a suburban neighborhood). The UE 1103 may be called a connected UE, e.g., if the UE 1103 is connected to the a network entity (e.g., a server) as part of or via the wireless signaling device 1101.

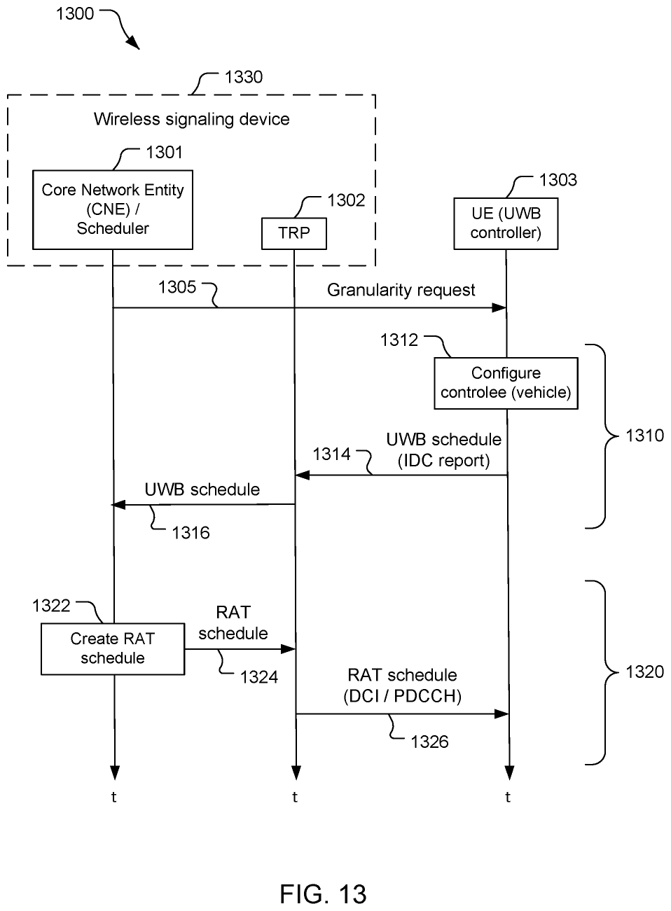

At stage 1110, the UE 1103 may obtain a first signal transmission schedule. For example, at sub-stage 1112, the wireless signaling device 1101 may produce a first signal transmission schedule, e.g., a RAT schedule or a UWB schedule, although a RAT schedule is assumed for this discussion. A RAT schedule may include indications of timing of RAT frames, subframes within respective frames, slots within respective subframes, and symbols within respective slots. The RAT schedule includes parameters (e.g., channel, slot offset, etc.) for downlink (DL) signaling. The wireless signaling device 1101 may determine the RAT schedule based on one or more parameters of a UWB session sent by the UE 1103, e.g., as discussed below with respect to stage 1310 of FIG. 13. If the wireless signaling device 1101 includes a CNE and a TRP, then the CNE may determine and transmit a RAT schedule message with the RAT schedule to the TRP for wireless transmission by the TRP, and which may be received by one or more of the UEs 1103, 1104. The wireless signaling device 1101 may transmit a first signal transmission schedule message 1114 with the first signal transmission schedule, and the message 1114 may be received by the UE 1103. The wireless signaling device 1101 may transmit, e.g., periodically, the first signal transmission schedule message 1114 to the UE 1103, e.g., from a TRP in a DCI (Downlink Control Information) embedded in the PDCCH (Physical Downlink Control Channel). As another example, the wireless signaling device 1101 (e.g., another UE) may produce the first signal transmission schedule as a sidelink signal transmission schedule, or a UWB signal transmission schedule. In this case, the wireless signaling device 1101 may comprise a UE, such as the UE 1103. The wireless signaling device 1101 may determine the first signal transmission schedule based on one or more parameters of a UWB session, e.g., provided by the UE 1103, e.g., as discussed below with respect to stage 1310 of FIG. 13. The wireless signaling device 1101 may transmit a first signal transmission schedule message 1114 with the first signal transmission schedule and the UE 1103 may receive and decode the message 1114 to obtain the first signal transmission schedule. As another example, the UE 1103 may obtain the first signal transmission schedule by receiving first signals 1116 (e.g., RAT signals (e.g., DL signals, SL signals) or UWB signals) transmitted by the wireless signaling device 1101 in accordance with the first signal transmission schedule (e.g., indicated in the first signal transmission schedule message 1114). At sub-stage 1118, the UE 1103 may listen to (e.g., scan) a channel of the first signals 1116, measure the first signals 1116, determine the first signals 1116 that satisfy an interference threshold, and detect a pattern of the first signals 1116 that satisfy the interference threshold. For example, the first signals that satisfy the interference threshold may be the first signals that are received with a signal strength exceeding a signal strength interference threshold, or that have a SINR (Signal-to-Interference-plus-Noise Ratio) that exceed a SINR interference threshold. For example, the signal strength interference threshold may be −85 dBm (which may be about a receiver sensitivity value), corresponding to a SINR falling below (not exceeding) a SINR threshold value of −10 dB.

At stage 1120, a second signal transmission schedule (here a UWB signal transmission schedule) based on the first signal transmission schedule (obtained at stage 1110) may be produced and sent to the UE 1104. For example, at sub-stage 1122, the UE 1103, acting as a UWB controller, may produce a UWB schedule based on the first signal transmission schedule (e.g., a RAT signal transmission schedule (such as a sidelink signal transmission schedule), or a UWB signal transmission schedule, etc.). The UWB unit 550 of the UE 1103 may use one or more parameters of the first signal transmission schedule to choose UWB rounds, slots, and (as appropriate) UWB transmission offsets within the slots (relative to boundaries (e.g., starting times) of the slots that can be used for UWB signaling between the UEs 1103, 1104 to avoid signal overlap (in time and frequency (directly or via a harmonic)) of UWB and other signals (e.g., RAT signals, UWB signals, etc.). This may help avoid interference with the UWB signals by the other signals. A UWB transmission offset is a time offset from a boundary (e.g., a beginning) of a slot for a ranging packet within the slot. The offset delays transmission within the slot, with a ranging packet duration being about 150 μs and a slot being at least 1 ms. The UE 1103 may synchronize with the wireless signaling device 1101 (to which the UE 1103 is connected) and establish a time reference for the UWB session. The time boundaries, e.g., of slots of a UWB session and another signaling session (e.g., a RAT session) either line up, or any time offsets between the boundaries of the other signaling session and the UWB session are known by the UE 1103. The UE 1103 may produce a UWB signal transmission schedule based on the chosen UWB rounds and slots, and transmit the UWB schedule as a second signal transmission schedule in a second signal transmission schedule message 1124 (which may be an RCM or an RCUM and may be called a ranging control message) to the UE 1104, which will act as a UWB controlee. The second signal transmission schedule message 1124 may indicate parameters of the second signal transmission schedule, e.g., one or more signal transmission offsets. The UWB unit 550 may select a ranging block duration, may select a quantity of ranging rounds in each ranging block, and may select a quantity of ranging slots within each ranging round. The UWB unit 550 may be configured to make these selections based on a latency requirement for the UWB session and/or one or more durations of a signal transmission schedule of the other signaling session, e.g., a RAT frame duration, a RAT subframe duration, and/or a RAT symbol duration, or a UWB ranging block duration, a UWB ranging round duration, and/or a UWB ranging slot duration. A UWB ranging measurement may be made only once every ranging block (which is between 200 ms and 250 ms) and thus, if the latency requirement is tight, the UE 1103 may set a small block size (duration). For example, a device manufacturer (e.g., a car company) may impose shorter ranging blocks to reduce latency to a desired level for unlocking a car. This may also boost estimation accuracy due to more frequent measurements, which may result in higher power consumption. The UWB unit 550 may select a set of round indices (across ranging blocks), a set of slot indices in each of the selected rounds, and a set of slot offsets in each of the selected slots that do not overlap (in time and frequency) with one or more active signal transmissions of the other signaling session (i.e., other than the UWB session between the UEs 1103, 1104), and during which UWB transmissions are scheduled to occur.

At stage 1130, the UEs 1103, 1104 may transfer one or more UWB signals 1132 between them. The UWB signal(s) 1132 may be transferred in accordance with the second signal transmission schedule produced at stage 1120 to avoid interference with the first signals 1116 such that desired functionality of the UWB signal(s) 1132 may be achieved. For example, UWB communication may be achieved in a wireless-device-dense environment, e.g., to unlock a vehicle in the presence of many vehicles using, for example, RAT communication, and/or UWB communication.

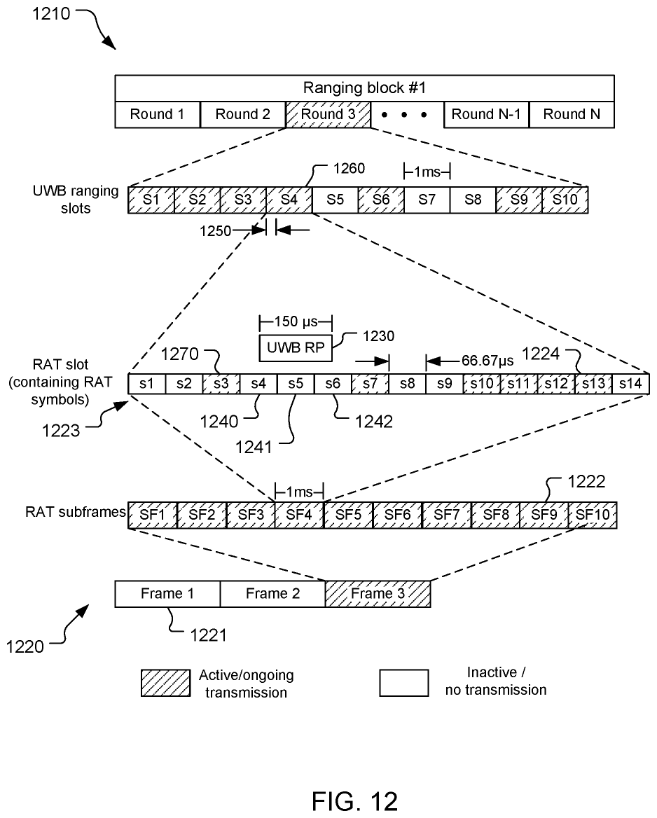

Referring also to FIG. 12, the UE 1103 (serving as a UWB controller) may schedule a UWB session to avoid interference with RAT transmissions. The UE 1103, e.g., the UWB unit 550, may produce a UWB schedule 1210 such that active/ongoing transmission times (of overlapping frequency) of a RAT schedule 1220 do not overlap with active/ongoing transmission times of the UWB schedule. Consequently, the RAT signaling and the UWB signaling may operate in a TDM (Time Division Multiplexed) manner at the RAT frame level. The RAT schedule 1220 is divided into frames 1221, subframes 1222 within the frames 1221, one or more slots 1223 within each of the subframes 1222, and symbols 1224 within each slot 1223 (e.g., 14 symbols in each slot 1223), and the UWB schedule is divided into blocks, rounds within blocks, and slots within rounds. A ranging round may be scheduled by the UE 1103 during an inactive RAT frame. The UE 1103 may use knowledge of a DRX (Discontinuous Reception) mode (and corresponding unused RAT frames) to determine the UWB schedule (e.g., with a UWB ranging round scheduled within an unused RAT frame). On a more granular scheduling level, the UE 1103 may schedule UWB ranging slots and transmission offsets to have ranging packets overlap with one or more inactive symbols within a RAT slot (that may have been scheduled as uplink (UL) or flexible) to help avoid interference. A UWB ranging packet is contained within a UWB ranging slot and has a duration of at least 150 μs, a RAT symbol has a duration of 66.67 μs or less (with the length depending on the numerology/SCS (Subcarrier Spacing), and a UWB ranging packet may be scheduled to overlap with inactive RAT symbols. As illustrated in FIG. 12 as an example, with an SCS of 15 kHz, the RAT slot 1223 will be 1 ms and thus each RAT subframe 1222 (which is 1 ms) will contain a single RAT slot. For example, a

UWB ranging packet 1230 (UWB RP) may be scheduled to overlap with a portion of an inactive symbol 1240, an inactive symbol 1241, and a portion of an inactive symbol 1242 of the RAT schedule 1220 based on the ranging packet having an offset 1250, within a UWB slot 1260, to avoid overlap with an active RAT symbol 1270.

Techniques discussed with respect to FIGS. 11 and 12 may be particularly useful for inter-device coexistence, avoiding interference of signal transmissions from different devices. Techniques discussed herein may be useful for facilitating In-Device Coexistence (IDC). Due to extreme proximity of multiple radio transceivers within a single UE operating on the same and/or adjacent frequencies or sub-harmonic frequencies, interference power from transmitter that is received by a co-located receiver may be much higher than the receiver is configured to accommodate for a desired received signal. Techniques are discussed herein for time division multiplexing signaling for different co-located devices (e.g., a transmitter and a receiver, e.g., of respective transceivers), e.g., by adapting a RAT schedule to a UWB schedule. Previous techniques for coexistence of LTE and Bluetooth® or coexistence of LTE and ISM/GNSS used assignments of some subframes for LTE and other subframes for Bluetooth® or ISM/GNSS.

Referring also to FIG. 13, a signal and processing flow 1300 for determining and providing a first signal transmission schedule in view of a second signal transmission schedule, for IDC and where the second signal transmission schedule is a UWB signal transmission schedule, includes the stages shown. The flow 1300 is an example flow and not limiting. The flow 1300 may be altered, e.g., by having one or more messages and/or one or more stages added and/or having one or more messages and/or one or more stages split into multiple messages and/or stages. In the flow 1300, signals are transferred among a wireless signaling device 1330 (here including a CNE/scheduler 1301 and a TRP 1302), and a UE 1303. The CNE/scheduler 1301 may be an example of the network entity 600. The TRP 1302 may be an example of the TRP 300. The UE 1303 may be an example of the UE 500, with the UE 1303 acting as a UWB controller. For example, the UE 1303 may intend to initiate a UWB ranging session with a vehicle. In the example shown, the wireless signaling device 1330 includes the CNE/scheduler 1301 and the TRP 1302. The wireless signaling device 1330 may alternatively comprise a UE, e.g., for SL signaling and/or UWB signaling, or another device. The discussion of the flow 1300 focuses on the shown example of the wireless signaling device 1330 comprising the CNE/scheduler 1301 and the TRP 1302, but the flow 1300 is applicable to other implementations, e.g., with the wireless signaling device 1330 being a UE.

At stage 1310, the UE 1303 may determine UWB session parameters of a UWB schedule (a second signal transmission schedule), configure a UWB controlee (e.g., a vehicle) for a UWB session, and report the UWB schedule to the TRP 1302. At sub-stage 1312, the UE 1303, e.g., the UWB unit 550, determines parameters of a UWB schedule that may include a beginning of a UWB ranging block, a periodicity of the UWB ranging block, a quantity and durations of ranging rounds within a ranging block, a quantity and durations of ranging slots within a ranging round, a ranging hopping pattern, and slot allocation within a ranging round. To enable pre-emptive communication of the UWB schedule to wireless signaling device 1330, here the CNE/scheduler 1301, the UWB session parameters may be restrained to a single set of parameters (that the controlee is known to support). Alternatively, these parameters may have been pre-configured and stored (e.g., in the memory 530) from an earlier session between the same two devices (i.e., the UE 1303 and the controlee). The UE 1303 may transmit a UWB schedule message 1314 indicating one or more of the parameters of the UWB schedule, and the TRP 1302 may forward the UWB schedule to the wireless signaling device 1330, in this example the CNE/scheduler 1301, in a UWB schedule message 1316. The UE 1303 may transmit the UWB schedule message 1314 in response to a trigger, e.g., movement of the UE 1303, a coarse location of the UE 1303 being within a trigger zone, or the UE 1303 receiving a response to a Bluetooth® (or other short-range wireless protocol) ping that the UE 1303 periodically transmits, or another trigger. The UE 1303 may request support from the CNE/scheduler 1301 in an IDC report packet of the UWB schedule message 1314. The UE 1303 may, for example, request the CNE/scheduler 1301 to avoid the sole frequency band with which the UE 1303 is configured to use (e.g., for UWB signaling). Rather than providing a detailed UWB schedule to the CNE/scheduler 1301 via the TRP 1302, the UWB schedule message 1314 may provide a set of reserved durations (e.g., start and stop times for UWB transmissions) to be avoided by the CNE/scheduler 1301 in a RAT schedule.

The UE 1303 may indicate UWB schedule parameters for coarse-grain scheduling of RAT signaling or fine-grain scheduling of RAT signaling. For coarse-grain scheduling, the UWB schedule message 1314 may indicate high-level information such as a continuous period of time (e.g., an entire ranging round) that may be reserved for UWB transmissions. This may serve to cause the CNE/scheduler 1301 to disable an entire RAT subframe (or an entire UWB ranging block or an entire UWB ranging slot) to accommodate UWB signaling. The UWB schedule message 1314 may indicate potential UWB channels that may be used, round duration, a start time of a next expected round, and/or a UWB packet error rate (e.g., over a past time interval), etc. The packet error rate is a packet loss rate due to interference. One or more of the parameters indicated in the UWB schedule message 1314 for coarse-grain scheduling may be indicated by a bitmap. For example, 0's and 1's in particular locations of the UWB schedule message 1314 may indicate whether respective channels will be used for the UWB schedule. As another example, 0's in particular locations, corresponding to known round durations, of the UWB schedule message 1314 may indicate that respective round durations will not be used while a 1 in a particular location corresponding to a round duration indicates that the corresponding round duration will be used. As another example, one or more parameters may be represented by binary values. For example, channel number 9 may be indicated by a binary 1001, and/or a start of a next expected round may be represented by a binary indication of a time duration in seconds (or minutes).

For fine-grain scheduling, the UWB schedule message 1314 may indicate lower-level information from which a finer RAT schedule (e.g., finer time granularity of use for RAT signaling versus being available for UWB signaling) may be determined. For example, fine-grain signaling may be at the UWB slot and RAT symbol level of resolution, such that the CNE/scheduler 1301 may determine whether to disable or enable on a symbol-to-symbol basis. The UWB schedule message 1314 may indicate potential UWB channels that may be used, block duration, block periodicity, round index (that may change, e.g., periodically), round duration, minimum number of slots within a round, slot duration, and/or UWB packet error rate, etc. One or more of the parameters indicated in the UWB schedule message 1314 for fine-grain scheduling may be indicated by a bitmap.

The CNE/scheduler 1301 may request the UE 1303 to provide coarse-grain scheduling information or fine-grain scheduling information. For example, the CNE/scheduler 1301 may transmit a granularity request message 1305 to the UE 1303 (e.g., via the TRP 1302). For example, the granularity request message 1305 may indicate to the UE 1303 that the CNE/scheduler 1301 would like the UE 1303 to transmit coarse-grain scheduling information in the UWB schedule message 1314 (e.g., if the CNE/scheduler 1301 is busy, e.g., due to being in a crowded environment). As another example, the granularity request message 1305 may indicate to the UE 1303 that the CNE/scheduler 1301 would like the UE 1303 to transmit fine-grain scheduling information in the UWB schedule message 1314 (e.g., if the CNE/scheduler 1301 is not busy, e.g., due to an uncrowded environment around the CNE/scheduler 1301 such as a single UE in a neighborhood). As another example, the granularity request message 1305 may indicate to the UE 1303 that the CNE/scheduler 1301 is willing to determine fine-grain RAT scheduling and thus that the UE 1303 may transmit fine-grain scheduling information in the UWB schedule message 1314.

At stage 1320, the wireless signaling device 1330, in this example the CNE/scheduler 1301 (e.g., the RAT unit 650), may use the UWB schedule received from the UE 1303 via the TRP 1302 to determine a first signal transmission schedule, in this example a RAT schedule (or a UWB signal transmission schedule, etc., in another example). The RAT unit 650 may produce a new RAT schedule or may modify an existing RAT schedule. The CNE/scheduler 1301 may determine the RAT schedule to avoid interference of RAT signals with UWB signals transferred in accordance with the UWB schedule//indicated in the UWB schedule message 1316. For example, the RAT schedule may be for a specific beam of the TRP 1302 to try to limit the number of UEs affecting by RAT transmissions while accommodating the UE requesting the CNE/scheduler 1301 to set the RAT schedule to avoid interference with the requesting UE, here the UE 1303. The CNE/scheduler 1301 may transmit the determined first signal transmission schedule (here the RAT schedule) to the TRP 1302 in a first signal transmission schedule message, in this example a RAT schedule message 1324, and the TRP 1302 may forward the first signal transmission schedule to the UE 1303, here in a RAT schedule message 1326 (e.g., in a DCI using the PDCCH). The UE 1303 may (or may not) modify the UWB schedule based on the received first signal transmission schedule. If the UE 1303 modifies the UWB schedule, the UE 1303 may try to ensure that UWB transmissions according to the modified UWB schedule do not overlap with signal transmissions according to the first signal transmission schedule, e.g., received in the RAT schedule message 1326.

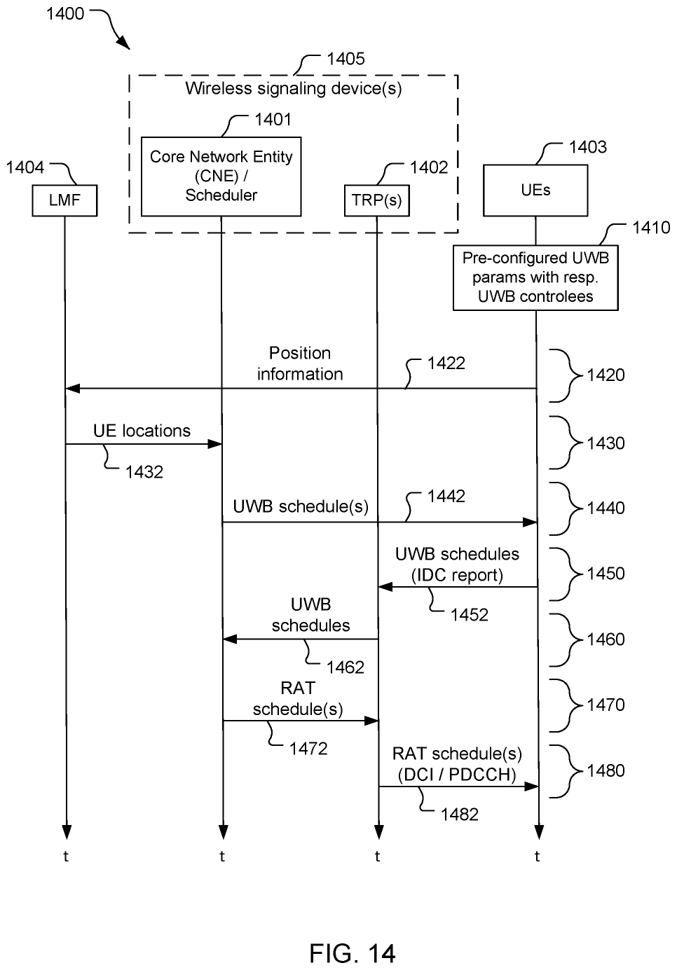

Referring also to FIG. 14, a signal and processing flow 1400 for determining and providing a first signal transfer schedule (in this example a RAT schedule) in view of second signal transmission schedules (in this example UWB schedules, for IDC), includes the stages shown. The flow 1400 is an example flow and not limiting. The flow 1400 may be altered, e.g., by having one or more messages and/or one or more stages added and/or having one or more messages and/or one or more stages split into multiple messages and/or stages. In the flow 1400, signals are transferred among one or more wireless signaling devices 1405 (here including a CNE/scheduler 1401 and one or more TRPs 1402), multiple UEs 1403, and an LMF 1404. The CNE/scheduler 1401 may be an example of the network entity 600. The TRP(s) 1402 may each be an example of the TRP 300. The UEs 1403 may each be an example of the UE 500, with the UEs 1403 acting as UWB controllers. In the example shown, the wireless signaling device(s) 1405 includes the CNE/scheduler 1401 and the TRP(s) 1402. The wireless signaling device(s) 1405 may comprise one or more UEs, e.g., for SL signaling and/or UWB signaling (e.g., instead of the example of the CNE/scheduler 1401 and the TRP(s) 1402 shown), and/or one or more other devices. The discussion of the flow 1400 focuses on the shown example of the wireless signaling device(s) 1405 comprising the CNE/scheduler 1401 and the TRP(s) 1402, but the flow 1400 is applicable to other implementations, e.g., with the wireless signaling device(s) 1405 being one or more UEs.

At stage 1410, the UEs 1403 may determine one or more sets of UWB scheduling parameters for respective UWB sessions with respective controlees. One or more of the one or more sets of UWB scheduling parameters may be pre-configured (e.g., having been determined from one or more previous UWB sessions).

At stage 1420, the UEs may transmit respective position information messages 1422 to the LMF 1404 (e.g., via the TRP(s) 1402). Each of the position information messages 1422 may include position information such as a coarse position estimate (e.g., based on eCID or SPS measurements) for the respective UE 1403, and/or one or more positioning measurements (e.g., SPS measurements, PRS measurements) that may be used by the LMF 1404 to determine a respective position estimate for the respective UE 1403. Transmitting the position information messages 1422 may be omitted from the flow 1400, and if transmitted, may be transmitted using LPP and/or another suitable protocol.

At stage 1430, the LMF 1404 may obtain and/or determine, and transmit, the locations of the UEs 1404 in a UE location message 1432 (or multiple location messages) to the wireless signaling device(s) 1405. For example, the LMF 1404 may transmit one or more UE location messages to the CNE/scheduler 1401 with the locations (i.e., location estimates) of the UEs 1403.

At stage 1440, the wireless signaling device(s) 1405 (in this example the CNE/scheduler 1401) may determine and transmit requested parameters for UWB schedules to the UEs 1403 in respective UWB schedule messages 1442. The requested parameters may be determined by the CNE/scheduler 1401 to try to avoid interference between UWB sessions of the UEs 1403. For example, the CNE/scheduler 1401 may determine the requested parameters based on one or more pairs of the UEs 1403 being close enough to have UWB sessions of different pairs of the UEs 1403 interfere. The requested parameters may, for example, request to have UWB signaling of the different UWB sessions, that might interfere, be time division multiplexed (having non-overlapping time windows for UWB transmissions) to avoid such interference. The requested parameters may request a granularity of such time division multiplexing at a RAT subframe level, a RAT slot level, or a RAT symbol level (e.g., as shown in FIG. 12). The CNE/scheduler 1401 may determine which UWB session may interfere with each other based on one or more UE locations provided at stage 1420 and/or one or more UE locations determined at stage 1430. Stage 1440 is optional, as the wireless signaling device(s) 1405 (here the CNE/scheduler 1401) may not obtain or determine UE locations, and/or may not request or recommend UWB parameters to avoid interference between UWB sessions of the UEs 1403.

At stage 1450, the UEs 1403 may transmit UWB schedules of respective UWB sessions to the wireless signaling device(s) 1405 (in this example to the TRP(s) 1402) in UWB schedule messages 1452 (e.g., IDC reports). One or more of the UWB schedules may be determined by one or more of the UEs 1403 based on one or more of UWB schedule requests of one or more of the UWB schedule messages 1442.

At stage 1460, in this example the TRP(s) 1402 may relay the UWB schedules to the CNE/scheduler 1401 in one or more UWB schedule messages 1462. The TRP(s) 1402 may transmit a UWB schedule message 1462 for each of the UWB schedules messages 1452, or may bundle two or more of the UWB schedules into each of one or more UWB schedule messages 1462. Stage 1460 may be omitted, e.g., if the wireless signaling device(s) 1405 comprises a UE and not the CNE/scheduler 1401 and the TRP(s) 1402.

At stage 1470, in this example the CNE/scheduler 1401 may transmit one or more first signal transmission schedules (here one or more RAT schedules) to one or more of the TRP(s) 1402 in one or more first signal transmission schedule messages, in this example, one or more RAT schedules in one or more RAT schedule messages 1472. The RAT schedule(s) may be determined by the CNE/scheduler 1401 (e.g., similarly to sub-stage 1322 discussed above) to avoid interference between RAT transmissions and UWB transmissions, e.g., based on the UWB schedules received at stage 1460. Transfer of the first signal transmission schedules between the CNE/scheduler 1401 and the TRP(s) 1402 at stage 1480 may be omitted if the wireless signaling device(s) 1405 comprises a UE and not the CNE/scheduler 1401 and the TRP(s) 1402.

At stage 1480, the wireless signaling device(s) 1405 (in this example the TRP(s) 1402) may transmit (e.g., relay or forward) the determined first signal transmission schedule(s) (here the RAT schedule(s)) to the UEs 1403 in one or more RAT schedule messages 1482. The RAT schedule may be different for each of the TRP(s) 1402 (or different for each of the wireless signaling device(s) 1405). Each of the RAT schedule messages 1482 may be sent as a DCI using the PDCCH from the TRP(s) 1402 (or another appropriate protocol and channel for another implementation of the wireless signaling device(s) 1405).

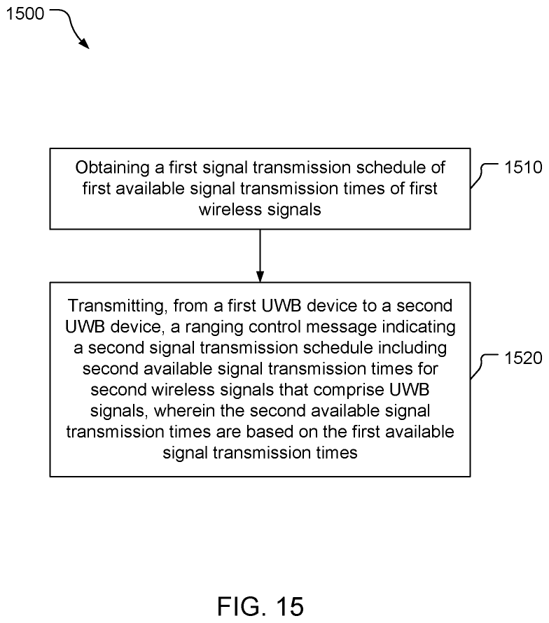

Referring to FIG. 15, with further reference to FIGS. 1-14, a method 1500 of scheduling a UWB ranging session includes the stages shown. The method 1500 is, however, an example only and not limiting. The method 1500 may be altered, e.g., by having one or more stages added, removed, rearranged, combined, performed concurrently, and/or by having one or more single stages split into multiple stages.

At stage 1510, the method 1500 includes obtaining a first signal transmission schedule of first available signal transmission times of first wireless signals. For example, at stage 1110, the UE 1103 may receive the first signal transmission schedule (e.g., a RAT schedule) in the first signal transmission schedule message 1112 for the wireless signaling device 1102. As another example, the UE 1103 may learn the first signal transmission schedule from the first signals 1116. The first wireless signals may be the same signal (e.g., repetitions (e.g., instances) of the same signal) or may be different signals. The processor 510, possibly in combination with the memory 530, possibly in combination with the transceiver 520 (e.g., the wireless receiver 244 and the antenna 246) may comprise means for obtaining the first signal transmission schedule. As another example, the processor 510 of the UE 1103 may retrieve the first signal transmission schedule from the memory 530 (e.g., in response to a trigger, e.g., receiving a signal from the TRP 1102). The processor 510, possibly in combination with the memory 530, may comprise means for obtaining the first signal transmission schedule. The first wireless signals may be RAT signals, UWB signals, etc. and may transmitted by the UE 1103 or by another device, e.g., the TRP 1102.

At stage 1520, the method 1500 includes transmitting, from a first UWB device to a second UWB device, a ranging control message indicating a second signal transmission schedule including second available signal transmission times for second wireless signals that comprise UWB signals, wherein the second available signal transmission times are based on the first available signal transmission times. For example, at stage 1120, the UE 1103 may transmit a UWB schedule to the UE 1104 in the second signal transmission schedule message 1124. The processor 510, possibly in combination with the memory 530, in combination with the transceiver 520 (e.g., the wireless transmitter 242 and the antenna 246) may comprise means for transmitting the ranging control message.

Implementations of the method 1500 may include one or more of the following features. In an example implementation, the second available signal transmission times are time division multiplexed with the first available signal transmission times. In another example implementation, the method 1500 further includes synchronizing the first UWB device with a wireless signaling device from which the first signal transmission schedule is obtained. For example, at stage 1120, the UE 1103 may synchronize with the wireless signaling device 1102 (from which the UE 1103 receives or learns the first signal transmission schedule). The processor 510, possibly in combination with the memory 530, in combination with the transceiver 520 (e.g., the wireless transmitter 242, the wireless receiver 244, and the antenna 246) may comprise means for synchronizing with the wireless signaling device. In another example implementation, the ranging control message indicates at least one second-signal-transmission offset relative to a ranging slot boundary to avoid overlap of transmission of any of the second wireless signals and at least one of the first available signal transmission times. For example, the second signal transmission schedule message 1124 may indicate the offset 1250 so that transmission of a ranging packet may occur during the duration 1230 (in the slot 1260) that does not overlap with the slot 1270 even though portions of the slots 1260, 1270 do overlap. In another example implementation, at least one of the second available signal transmission times corresponds to an unscheduled reception time of a discontinuous reception mode schedule. In another example implementation, the method 1500 further includes determining the second signal transmission schedule based on a UWB latency requirement. For example, at sub-stage 1122, the UE 1103, e.g., the UWB unit 550, may determine a UWB schedule based on a latency requirement for the UWB session. The processor 510, possibly in combination with the memory 530, may comprise means for determining the second signal transmission schedule based on a UWB latency requirement. In another example implementation, the method 1500 includes determining the second signal transmission schedule based on at least one of a signal transmission frame duration, a signal transmission subframe duration, a signal transmission symbol duration, a ranging round duration, or a ranging slot duration. For example, at sub-stage 1122, the UE 1103, e.g., the UWB unit 550, may determine the UWB schedule based on at least one of a base station signal transmission frame duration, a base station signal transmission subframe duration, a base station signal transmission symbol duration, a ranging round duration, or a ranging slot duration of a signal transmission schedule of the wireless signaling device 1102 (e.g., a TRP, another UE, or the UE 1103). The processor 510, possibly in combination with the memory 530, may comprise means for determining the second signal transmission schedule based on at least one of a signal transmission frame duration, a signal transmission subframe duration, a signal transmission symbol duration, a ranging round duration, or a ranging slot duration.

Also or alternatively, implementations of the method 1500 may include one or more of the following features. In an example implementation, the method 1500 includes transmitting, from the first UWB device to a wireless signaling device, at least one parameter of an expected UWB ranging signal transmission schedule, the at least one parameter comprising: (1) a beginning of a UWB ranging block and a periodicity of the UWB ranging block; or (2) a first quantity of ranging rounds within the ranging block and durations of the ranging rounds; or (3) a second quantity of ranging slots within each of the ranging rounds and durations of the ranging slots; or (4) a ranging round hopping pattern; or (5) a ranging round slot allocation; or (6) any combination of two or more of (1)-(5). For example, the UE 1103 may transmit one or more of these UWB session parameters to the CNE 1101 for the CNE 1101 to produce the RAT schedule. The processor 510, possibly in combination with the memory 530, in combination with the transceiver 520 (e.g., the wireless transmitter 242 and the antenna 246) may comprise means for transmitting the at least one parameter of an expected UWB ranging signal transmission schedule. In another example implementation, obtaining the first signal transmission schedule comprises detecting a pattern of the first wireless signals that satisfy an interference threshold. For example, at sub-state 1118, the UE 1103 may measure the first signals 1116 and detect a pattern of the first signals 1116 that exceed an interference threshold (e.g., signal strength threshold or SINR threshold). The processor 510, possibly in combination with the memory 530, in combination with the transceiver 520 (e.g., the wireless receiver 244 and the antenna 246) may comprise means for detecting the pattern of the first wireless signals that satisfy an interference threshold.

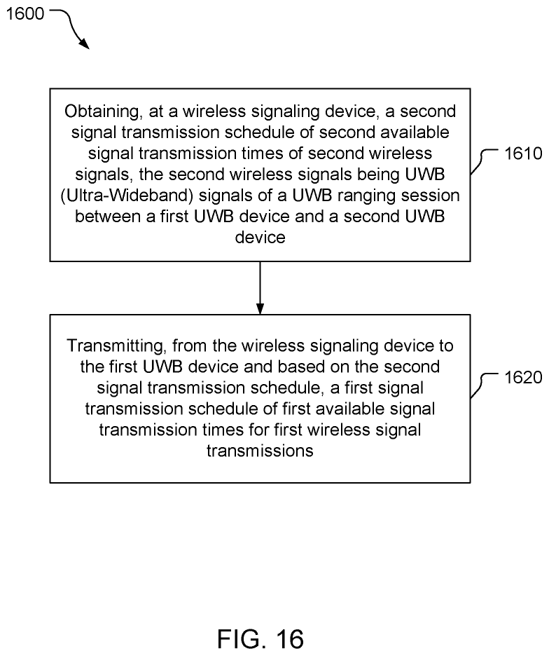

Referring to FIG. 16, with further reference to FIGS. 1-14, a method 1600 of scheduling wireless signaling device signal transmissions includes the stages shown. The method 1600 is, however, an example only and not limiting. The method 1500 may be altered, e.g., by having one or more stages added, removed, rearranged, combined, performed concurrently, and/or by having one or more single stages split into multiple stages.

At stage 1610, the method 1600 includes obtaining, at a wireless signaling device, a second signal transmission schedule of second available signal transmission times of second wireless signals, the second wireless signals being UWB (Ultra-Wideband) siganls of a UWB ranging session between a first UWB device and a second UWB device. For example, at stage 1310, the wireless signaling device 1330 may obtain a UWB signal transmission schedule. For example, a UE or the CNE/scheduler 1301 (via the TRP 1302) may receive the UWB schedule in the UWB schedule message 1316 indicating UWB transmission times for a UWB session between the UE 1303 and a controlee. The processor 610, possibly in combination with the memory 630, in combination with the transceiver 620 (e.g., the wireless receiver 444 and the antenna 446, and/or the wired receiver 454) may comprise means for obtaining the second signal transmission schedule. The processor 510, possibly in combination with the memory 530, in combination with the transceiver 520 (e.g., the wireless receiver 244 and the antenna 246, and/or the wired receiver 254) may comprise means for obtaining the second signal transmission schedule. As another example, at stage 1450 or at stages 1450, 1460, the wireless signaling device 1405 may receive UWB schedules.

At stage 1620, the method 1600 includes transmitting, from the wireless signaling device to the first UWB device and based on the second signal transmission schedule, a first signal transmission schedule of first available signal transmission times for first wireless signal transmissions. For example, at stage 1320, the wireless signaling device 1330 may transmit the RAT schedule message 1326 to the UE 1303 (e.g., the CNE/scheduler 1301 may transmit the RAT schedule in the RAT schedule message 1324 for the UE 1303 and the TRP 1302 may transmit the RAT schedule message 1326 to the UE 1303, or a UE may transmit the message 1326 to the UE 1303. The processor 610, possibly in combination with the memory 630, in combination with the transceiver 620 (e.g., the wireless transmitter 442 and the antenna 446, and/or the wired transmitter 452) may comprise means for transmitting the first signal transmission schedule. The processor 510, possibly in combination with the memory 530, in combination with the transceiver 520 (e.g., the wireless transmitter 242 and the antenna 246, and/or the wired transmitter 252) may comprise means for transmitting the first signal transmission schedule.

Implementations of the method 1600 may include one or more of the following features. In an example implementation, the first available signal transmission times are time division multiplexed with the second available signal transmission times. In another example implementation, the UWB ranging session is a first UWB ranging session, and the method 1600 further includes: obtaining a third signal transmission schedule of third available signal transmission times of third wireless signals, the third wireless signals being UWB signals of a second UWB ranging session between a third UWB device and a fourth UWB device, wherein the first UWB device and the third UWB device are within a threshold distance of each other; and transmitting, from the wireless signaling device to the third UWB device and based on the second signal transmission schedule and the third signal transmission schedule, the first signal transmission schedule of first available signal transmission times for first wireless signal transmissions, wherein the first available signal transmission times for first wireless signal transmissions are time division multiplexed with the second available signal transmission times and the third available signal transmission times. For example, the wireless signaling device 1405 (e.g., a UE or the CNE/scheduler 1401 via the TRP(s) 1402) may receive multiple UWB schedules from multiple ones of the UEs 1403 in the UWB schedule messages 1452 (and the UWB schedule messages 1462 as appropriate), with the UWB schedules corresponding to UWB sessions that may interfere with each other, and transmit one or more second signal transmission schedules (e.g., RAT schedules) in one or more messages (e.g., the RAT schedule message(s) 1482 (possibly via the RAT schedule message(s) 1472) for respective ones of the UEs 1403, e.g., with at least one of the second signal transmission schedules configured such that first available signal transmission times do not overlap with second available signal transmission times (UWB signal transmission times) of any of the multiple UWB sessions. The processor 610, possibly in combination with the memory 630, in combination with the transceiver 620 (e.g., the wireless receiver 444 and the antenna 446, and/or the wired receiver 454) may comprise means for obtaining the third signal transmission schedule. The processor 610, possibly in combination with the memory 630, in combination with the transceiver 620 (e.g., the wireless transmitter 442 and the antenna 446, and/or the wired transmitter 452) may comprise means for transmitting the first signal transmission schedule. The processor 510, possibly in combination with the memory 530, in combination with the transceiver 520 (e.g., the wireless receiver 244 and the antenna 246, and/or the wired receiver 254) may comprise means for obtaining the third signal transmission schedule. The processor 510, possibly in combination with the memory 530, in combination with the transceiver 520 (e.g., the wireless transmitter 242 and the antenna 246, and/or the wired transmitter 252) may comprise means for transmitting the first signal transmission schedule.

Also or alternatively, implementations of the method 1600 may include one or more of the following features. In an example implementation, the first signal transmission schedule depends on a continuous period of time reserved for UWB signal transmissions as indicated in the second signal transmission schedule. In another example implementation, the first signal transmission schedule allocates a coarse-grain availability for UWB signal transmissions based on one or more parameters of the second signal transmission schedule, with every time duration allocated for UWB signal transmission being at least a subframe of the first signal transmission schedule with the first signal transmission schedule being either a cellular signal transmission schedule or a sidelink signal transmission schedule, or being at least a slot of the first signal transmission schedule with the first signal transmission schedule being a UWB signal transmission schedule. In another example implementation, the first signal transmission schedule allocates a fine-grain availability for UWB signal transmissions based on one or more parameters of the second signal transmission schedule, with a time duration allocated for UWB signal transmission being a single symbol of the first signal transmission schedule. In another example implementation, the first signal transmission schedule depends on a UWB packet error rate received by the wireless signaling device from the first UWB device.

### Implementation Examples

Implementation examples are provided in the following numbered clauses.

Clause 1. A method of scheduling a UWB (Ultra-Wideband) ranging session, the method comprising:
obtaining a first signal transmission schedule of first available signal transmission times of first wireless signals; and
transmitting, from a first UWB device to a second UWB device, a ranging control message indicating a second signal transmission schedule including second available signal transmission times for second wireless signals that comprise UWB signals, wherein the second available signal transmission times are based on the first available signal transmission times.

Clause 2. The method of clause 1, wherein the second available signal transmission times are time division multiplexed with the first available signal transmission times.

Clause 3. The method of clause 1, further comprising synchronizing the first UWB device with a wireless signaling device from which the first signal transmission schedule is obtained.

Clause 4. The method of clause 1, wherein the ranging control message indicates at least one second-signal-transmission offset relative to a ranging slot boundary to avoid overlap of transmission of any of the second wireless signals and at least one of the first available signal transmission times.

Clause 5. The method of clause 1, wherein at least one of the second available signal transmission times corresponds to an unscheduled reception time of a discontinuous reception mode schedule.

Clause 6. The method of clause 1, further comprising determining the second signal transmission schedule based on a UWB latency requirement.

Clause 7. The method of clause 1, further comprising determining the second signal transmission schedule based on at least one of a signal transmission frame duration, a signal transmission subframe duration, a signal transmission symbol duration, a ranging round duration, or a ranging slot duration.

Clause 8. The method of clause 1, further comprising transmitting, from the first UWB device to a wireless signaling device, at least one parameter of an expected UWB ranging signal transmission schedule, the at least one parameter comprising: (1) a beginning of a UWB ranging block and a periodicity of the UWB ranging block; or (2) a first quantity of ranging rounds within the ranging block and durations of the ranging rounds; or (3) a second quantity of ranging slots within each of the ranging rounds and durations of the ranging slots; or (4) a ranging round hopping pattern; or (5) a ranging round slot allocation; or (6) any combination of two or more of (1)-(5).

Clause 9. The method of clause 1, wherein obtaining the first signal transmission schedule comprises detecting a pattern of the first wireless signals that satisfy an interference threshold.

Clause 10. A first UWB device (Ultra-Wideband device) comprising:
at least one transceiver configured to transmit and receive UWB signals;
at least one memory; and
at least one processor, communicatively coupled to the at least one transceiver and the at least one memory, configured to:
obtain a first signal transmission schedule of first available signal transmission times of first wireless signals; and
   transmit, via the at least one transceiver to a second UWB device, a ranging control message indicating a second signal transmission schedule including second available signal transmission times for second wireless signals that comprise UWB signals, wherein the second available signal transmission times are based on the first available signal transmission times.

Clause 11. The first UWB device of clause 10, wherein the second available signal transmission times are time division multiplexed with the first available signal transmission times.

Clause 12. The first UWB device of clause 10, wherein the at least one processor is further configured to synchronize the first UWB device with a wireless signaling device from which the first signal transmission schedule is obtained.

Clause 13. The first UWB device of clause 10, wherein the ranging control message indicates at least one second-signal-transmission offset relative to a ranging slot boundary to avoid overlap of transmission of any of the second wireless signals and at least one of the first available signal transmission times.

Clause 14. The first UWB device of clause 10, wherein at least one of the second available signal transmission times corresponds to an unscheduled reception time of a discontinuous reception mode schedule.

Clause 15. The first UWB device of clause 10, wherein the at least one processor is further configured to determine the second signal transmission schedule based on a UWB latency requirement.

Clause 16. The first UWB device of clause 10, wherein the at least one processor is further configured to determine the second signal transmission schedule based on at least one of a signal transmission frame duration, a signal transmission subframe duration, a signal transmission symbol duration, a ranging round duration, or a ranging slot duration.

Clause 17. The first UWB device of clause 10, wherein the at least one processor is further configured to transmit, via the at least one transceiver to a wireless signaling device, at least one parameter of an expected UWB ranging signal transmission schedule, the at least one parameter comprising: (1) a beginning of a UWB ranging block and a periodicity of the UWB ranging block; or (2) a first quantity of ranging rounds within the ranging block and durations of the ranging rounds; or (3) a second quantity of ranging slots within each of the ranging rounds and durations of the ranging slots; or (4) a ranging round hopping pattern; or (5) a ranging round slot allocation; or (6) any combination of two or more of (1)-(5).

Clause 18. The first UWB device of clause 10, wherein to obtain the first signal transmission schedule the at least one processor is configured to detect a pattern of the first wireless signals that satisfy an interference threshold.

Clause 19. A first UWB device (Ultra-Wideband device) comprising:
means for obtaining a first signal transmission schedule of first available signal transmission times of first wireless signals; and
means transmitting, to a second UWB device, a ranging control message indicating a second signal transmission schedule including second available signal transmission times for second wireless signals that comprise UWB signals, wherein the second available signal transmission times are based on the first available signal transmission times.

Clause 20. The first UWB device of clause 19, wherein the second available signal transmission times are time division multiplexed with the first available signal transmission times.

Clause 21. The first UWB device of clause 19, further comprising means for synchronizing the first UWB device with a wireless signaling device from which the first signal transmission schedule is obtained.

Clause 22. The first UWB device of clause 19, wherein the ranging control message indicates at least one second-signal-transmission offset relative to a ranging slot boundary to avoid overlap of transmission of any of the second wireless signals and at least one of the first available signal transmission times.

Clause 23. The first UWB device of clause 19, wherein at least one of the second available signal transmission times corresponds to an unscheduled reception time of a discontinuous reception mode schedule.

Clause 24. The first UWB device of clause 19, further comprising means for determining the second signal transmission schedule based on a UWB latency requirement.

Clause 25. The first UWB device of clause 19, further comprising means for determining the second signal transmission schedule based on at least one of a signal transmission frame duration, a signal transmission subframe duration, a signal transmission symbol duration, a ranging round duration, or a ranging slot duration.

Clause 26. The first UWB device of clause 19, further comprising means for transmitting, to a wireless signaling device, at least one parameter of an expected UWB ranging signal transmission schedule, the at least one parameter comprising: (1) a beginning of a UWB ranging block and a periodicity of the UWB ranging block; or (2) a first quantity of ranging rounds within the ranging block and durations of the ranging rounds; or (3) a second quantity of ranging slots within each of the ranging rounds and durations of the ranging slots; or (4) a ranging round hopping pattern; or (5) a ranging round slot allocation; or (6) any combination of two or more of (1)-(5).

Clause 27. The first UWB device of clause 19, wherein the means for obtaining the first signal transmission schedule comprise means for detecting a pattern of the first wireless signals that satisfy an interference threshold.

Clause 28. A non-transitory, processor-readable storage medium comprising processor-readable instructions to cause at least one processor of a first UWB device (Ultra-Wideband device) to:
obtain a first signal transmission schedule of first available signal transmission times of first wireless signals; and
transmit, to a second UWB device, a ranging control message indicating a second signal transmission schedule including second available signal transmission times for second wireless signals that comprise UWB signals, wherein the second available signal transmission times are based on the first available signal transmission times.

Clause 29. The non-transitory, processor-readable storage medium of clause 28, wherein the second available signal transmission times are time division multiplexed with the first available signal transmission times.

Clause 30. The non-transitory, processor-readable storage medium of clause 28, further comprising processor-readable instructions to cause the at least one processor to synchronize the first UWB device with a wireless signaling device from which the first signal transmission schedule is obtained.

Clause 31. The non-transitory, processor-readable storage medium of clause 28, wherein the ranging control message indicates at least one second-signal-transmission offset relative to a ranging slot boundary to avoid overlap of transmission of any of the second wireless signals and at least one of the first available signal transmission times.

Clause 32. The non-transitory, processor-readable storage medium of clause 28, wherein at least one of the second available signal transmission times corresponds to an unscheduled reception time of a discontinuous reception mode schedule.

Clause 33. The non-transitory, processor-readable storage medium of clause 28, further comprising processor-readable instructions to cause the at least one processor to determine the second signal transmission schedule based on a UWB latency requirement.

Clause 34. The non-transitory, processor-readable storage medium of clause 28, further comprising processor-readable instructions to cause the at least one processor to determine the second signal transmission schedule based on at least one of a signal transmission frame duration, a signal transmission subframe duration, a signal transmission symbol duration, a ranging round duration, or a ranging slot duration.

Clause 35. The non-transitory, processor-readable storage medium of clause 28, further comprising processor-readable instructions to cause the at least one processor to transmit, to a wireless signaling device, at least one parameter of an expected UWB ranging signal transmission schedule, the at least one parameter comprising: (1) a beginning of a UWB ranging block and a periodicity of the UWB ranging block; or (2) a first quantity of ranging rounds within the ranging block and durations of the ranging rounds; or (3) a second quantity of ranging slots within each of the ranging rounds and durations of the ranging slots; or (4) a ranging round hopping pattern; or (5) a ranging round slot allocation; or (6) any combination of two or more of (1)-(5).

Clause 36. The non-transitory, processor-readable storage medium of clause 28, wherein the processor-readable instructions to cause the at least one processor to obtain the first signal transmission schedule comprise processor-readable instructions to cause the at least one processor to detect a pattern of the first wireless signals that satisfy an interference threshold.

Clause 37. A method of scheduling wireless signaling device signal transmissions, the method comprising:
obtaining, at a wireless signaling device, a second signal transmission schedule of second available signal transmission times of second wireless signals, the second wireless signals being UWB (Ultra-Wideband) signals of a UWB ranging session between a first UWB device and a second UWB device; and
transmitting, from the wireless signaling device to the first UWB device and based on the second signal transmission schedule, a first signal transmission schedule of first available signal transmission times for first wireless signal transmissions.

Clause 38. The method of clause 37, wherein the first available signal transmission times are time division multiplexed with the second available signal transmission times.

Clause 39. The method of clause 37, wherein the UWB ranging session is a first UWB ranging session, and the method further comprises:
obtaining a third signal transmission schedule of third available signal transmission times of third wireless signals, the third wireless signals being UWB signals of a second UWB ranging session between a third UWB device and a fourth UWB device, wherein the first UWB device and the third UWB device are within a threshold distance of each other; and
transmitting, from the wireless signaling device to the third UWB device and based on the second signal transmission schedule and the third signal transmission schedule, the first signal transmission schedule of first available signal transmission times for first wireless signal transmissions, wherein the first available signal transmission times for first wireless signal transmissions are time division multiplexed with the second available signal transmission times and the third available signal transmission times.

Clause 40. The method of clause 37, wherein the first signal transmission schedule depends on a continuous period of time reserved for UWB signal transmissions as indicated in the second signal transmission schedule.

Clause 41. The method of clause 37, wherein the first signal transmission schedule allocates a coarse-grain availability for UWB signal transmissions based on one or more parameters of the second signal transmission schedule, with every time duration allocated for UWB signal transmission being at least a subframe of the first signal transmission schedule with the first signal transmission schedule being either a cellular signal transmission schedule or a sidelink signal transmission schedule, or being at least a slot of the first signal transmission schedule with the first signal transmission schedule being a UWB signal transmission schedule.

Clause 42. The method of clause 37, wherein the first signal transmission schedule allocates a fine-grain availability for UWB signal transmissions based on one or more parameters of the second signal transmission schedule, with a time duration allocated for UWB signal transmission being a single symbol of the first signal transmission schedule.

Clause 43. The method of clause 37, wherein the first signal transmission

schedule depends on a UWB packet error rate received by the wireless signaling device from the first UWB device.

Clause 44. A wireless signaling device comprising:
at least one transceiver;
at least one memory; and
at least one processor, communicatively coupled to the at least one transceiver and the at least one memory, configured to:
   obtain a second signal transmission schedule of second available signal transmission times of second wireless signals, the second wireless signals being UWB (Ultra-Wideband) signals of a UWB ranging session between a first UWB device and a second UWB device; and
   transmit, via the at least one transceiver to the first UWB device and based on the second signal transmission schedule, a first signal transmission schedule of first available signal transmission times for first wireless signal transmissions.

Clause 45. The wireless signaling device of clause 44, wherein the first available signal transmission times are time division multiplexed with the second available signal transmission times.

Clause 46. The wireless signaling device of clause 44, wherein the UWB ranging session is a first UWB ranging session, and the at least one processor is further configured to:
obtain a third signal transmission schedule of third available signal transmission times of third wireless signals, the third wireless signals being UWB signals of a second UWB ranging session between a third UWB device and a fourth UWB device, wherein the first UWB device and the third UWB device are within a threshold distance of each other; and
transmit, via the at least one transceiver to the third UWB device and based on the second signal transmission schedule and the third signal transmission schedule, the first signal transmission schedule of first available signal transmission times for first wireless signal transmissions, wherein the first available signal transmission times for first wireless signal transmissions are time division multiplexed with the second available signal transmission times and the third available signal transmission times.

Clause 47. The wireless signaling device of clause 44, wherein the first signal transmission schedule depends on a continuous period of time reserved for UWB signal transmissions as indicated in the second signal transmission schedule.

Clause 48. The wireless signaling device of clause 44, wherein the first signal transmission schedule allocates a coarse-grain availability for UWB signal transmissions based on one or more parameters of the second signal transmission schedule, with every time duration allocated for UWB signal transmission being at least a subframe of the first signal transmission schedule with the first signal transmission schedule being either a cellular signal transmission schedule or a sidelink signal transmission schedule, or being at least a slot of the first signal transmission schedule with the first signal transmission schedule being a UWB signal transmission schedule.

Clause 49. The wireless signaling device of clause 44, wherein the first signal transmission schedule allocates a fine-grain availability for UWB signal transmissions based on one or more parameters of the second signal transmission schedule, with a time duration allocated for UWB signal transmission being a single symbol of the first signal transmission schedule.

Clause 50. The wireless signaling device of clause 44, wherein the first signal transmission schedule depends on a UWB packet error rate received by the wireless signaling device from the first UWB device.

Clause 51. A wireless signaling device comprising:
means for obtaining a second signal transmission schedule of second available signal transmission times of second wireless signals, the second wireless signals being UWB (Ultra-Wideband) signals of a UWB ranging session between a first UWB device and a second UWB device; and
means for transmitting, to the first UWB device and based on the second signal transmission schedule, a first signal transmission schedule of first available signal transmission times for first wireless signal transmissions.

Clause 52. The wireless signaling device of clause 51, wherein the first available signal transmission times are time division multiplexed with the second available signal transmission times.

Clause 53. The wireless signaling device of clause 51, wherein the UWB ranging session is a first UWB ranging session, and the wireless signaling device further comprises:
means for obtaining a third signal transmission schedule of third available signal transmission times of third wireless signals, the third wireless signals being UWB signals of a second UWB ranging session between a third UWB device and a fourth UWB device, wherein the first UWB device and the third UWB device are within a threshold distance of each other; and
means for transmitting, from the wireless signaling device to the third UWB device and based on the second signal transmission schedule and the third signal transmission schedule, the first signal transmission schedule of first available signal transmission times for first wireless signal transmissions, wherein the first available signal transmission times for first wireless signal transmissions are time division multiplexed with the second available signal transmission times and the third available signal transmission times.

Clause 54. The wireless signaling device of clause 51, wherein the first signal transmission schedule depends on a continuous period of time reserved for UWB signal transmissions as indicated in the second signal transmission schedule.

Clause 55. The wireless signaling device of clause 51, wherein the first signal transmission schedule allocates a coarse-grain availability for UWB signal transmissions based on one or more parameters of the second signal transmission schedule, with every time duration allocated for UWB signal transmission being at least a subframe of the first signal transmission schedule with the first signal transmission schedule being either a cellular signal transmission schedule or a sidelink signal transmission schedule, or being at least a slot of the first signal transmission schedule with the first signal transmission schedule being a UWB signal transmission schedule.

Clause 56. The wireless signaling device of clause 51, wherein the first signal transmission schedule allocates a fine-grain availability for UWB signal transmissions based on one or more parameters of the second signal transmission schedule, with a time duration allocated for UWB signal transmission being a single symbol of the first signal transmission schedule.

Clause 57. The wireless signaling device of clause 51, wherein the first signal transmission schedule depends on a UWB packet error rate received by the wireless signaling device from the first UWB device.

Clause 58. A non-transitory, processor-readable storage medium comprising processor-readable instructions to cause at least one processor of a wireless signaling device to:
obtain a second signal transmission schedule of second available signal transmission times of second wireless signals, the second wireless signals being UWB (Ultra-Wideband) signals of a UWB ranging session between a first UWB device and a second UWB device; and
transmit, to the first UWB device and based on the second signal transmission schedule, a first signal transmission schedule of first available signal transmission times for first wireless signal transmissions.

Clause 59. The non-transitory, processor-readable storage medium of clause 58, wherein the first available signal transmission times are time division multiplexed with the second available signal transmission times.

Clause 60. The non-transitory, processor-readable storage medium of clause 58, wherein the UWB ranging session is a first UWB ranging session, and the non-transitory, processor-readable storage medium further comprises processor-readable instructions to cause the at least one processor to:
obtain a third signal transmission schedule of third available signal transmission times of third wireless signals, the third wireless signals being UWB signals of a second UWB ranging session between a third UWB device and a fourth UWB device, wherein the first UWB device and the third UWB device are within a threshold distance of each other; and
transmit, from the wireless signaling device to the third UWB device and based on the second signal transmission schedule and the third signal transmission schedule, the first signal transmission schedule of first available signal transmission times for first wireless signal transmissions, wherein the first available signal transmission times for first wireless signal transmissions are time division multiplexed with the second available signal transmission times and the third available signal transmission times.

Clause 61. The non-transitory, processor-readable storage medium of clause 58, wherein the first signal transmission schedule depends on a continuous period of time reserved for UWB signal transmissions as indicated in the second signal transmission schedule.

Clause 62. The non-transitory, processor-readable storage medium of clause 58, wherein the first signal transmission schedule allocates a coarse-grain availability for UWB signal transmissions based on one or more parameters of the second signal transmission schedule, with every time duration allocated for UWB signal transmission being at least a subframe of the first signal transmission schedule with the first signal transmission schedule being either a cellular signal transmission schedule or a sidelink signal transmission schedule, or being at least a slot of the first signal transmission schedule with the first signal transmission schedule being a UWB signal transmission schedule.

Clause 63. The non-transitory, processor-readable storage medium of clause 58, wherein the first signal transmission schedule allocates a fine-grain availability for UWB signal transmissions based on one or more parameters of the second signal transmission schedule, with a time duration allocated for UWB signal transmission being a single symbol of the first signal transmission schedule.

Clause 64. The non-transitory, processor-readable storage medium of clause 58, wherein the first signal transmission schedule depends on a UWB packet error rate received by the wireless signaling device from the first UWB device.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function

Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of scheduling a UWB (Ultra-Wideband) ranging session, the method comprising:
obtaining a first signal transmission schedule of first available signal transmission times of first wireless signals; and
transmitting, from a first UWB device to a second UWB device, a ranging control message indicating a second signal transmission schedule including second available signal transmission times for second wireless signals that comprise UWB signals, wherein the second available signal transmission times are based on the first available signal transmission times.

2. The method of claim 1, wherein the second available signal transmission times are time division multiplexed with the first available signal transmission times.

3. The method of claim 1, further comprising synchronizing the first UWB device with a wireless signaling device from which the first signal transmission schedule is obtained.

4. The method of claim 1, wherein the ranging control message indicates at least one second-signal-transmission offset relative to a ranging slot boundary to avoid overlap of transmission of any of the second wireless signals and at least one of the first available signal transmission times.

5. The method of claim 1, wherein at least one of the second available signal transmission times corresponds to an unscheduled reception time of a discontinuous reception mode schedule.

6. The method of claim 1, further comprising determining the second signal transmission schedule based on a UWB latency requirement.

7. The method of claim 1, further comprising determining the second signal transmission schedule based on at least one of a signal transmission frame duration, a signal transmission subframe duration, a signal transmission symbol duration, a ranging round duration, or a ranging slot duration.

8. The method of claim 1, further comprising transmitting, from the first UWB device to a wireless signaling device, at least one parameter of an expected UWB ranging signal transmission schedule, the at least one parameter comprising: (1) a beginning of a UWB ranging block and a periodicity of the UWB ranging block; or (2) a first quantity of ranging rounds within the ranging block and durations of the ranging rounds; or (3) a second quantity of ranging slots within each of the ranging rounds and durations of the ranging slots; or (4) a ranging round hopping pattern; or (5) a ranging round slot allocation; or (6) any combination of two or more of (1)-(5).

9. The method of claim 1, wherein obtaining the first signal transmission schedule comprises detecting a pattern of the first wireless signals that satisfy an interference threshold.

10. A first UWB device (Ultra-Wideband device) comprising:
at least one transceiver configured to transmit and receive UWB signals;
at least one memory; and
at least one processor, communicatively coupled to the at least one transceiver and the at least one memory, configured to:
obtain a first signal transmission schedule of first available signal transmission times of first wireless signals; and
transmit, via the at least one transceiver to a second UWB device, a ranging control message indicating a second signal transmission schedule including second available signal transmission times for second wireless signals that comprise UWB signals, wherein the second available signal transmission times are based on the first available signal transmission times.

11. The first UWB device of claim 10, wherein the second available signal transmission times are time division multiplexed with the first available signal transmission times.

12. The first UWB device of claim 10, wherein the at least one processor is further configured to synchronize the first UWB device with a wireless signaling device from which the first signal transmission schedule is obtained.

13. The first UWB device of claim 10, wherein the ranging control message indicates at least one second-signal-transmission offset relative to a ranging slot boundary to avoid overlap of transmission of any of the second wireless signals and at least one of the first available signal transmission times.

14. The first UWB device of claim 10, wherein at least one of the second available signal transmission times corresponds to an unscheduled reception time of a discontinuous reception mode schedule.

15. The first UWB device of claim 10, wherein the at least one processor is further configured to determine the second signal transmission schedule based on a UWB latency requirement.

16. The first UWB device of claim 10, wherein the at least one processor is further configured to determine the second signal transmission schedule based on at least one of a signal transmission frame duration, a signal transmission subframe duration, a signal transmission symbol duration, a ranging round duration, or a ranging slot duration.

17. The first UWB device of claim 10, wherein the at least one processor is further configured to transmit, via the at least one transceiver to a wireless signaling device, at least one parameter of an expected UWB ranging signal transmission schedule, the at least one parameter comprising: (1) a beginning of a UWB ranging block and a periodicity of the UWB ranging block; or (2) a first quantity of ranging rounds within the ranging block and durations of the ranging rounds; or (3) a second quantity of ranging slots within each of the ranging rounds and durations of the ranging slots; or (4) a ranging round hopping pattern; or (5) a ranging round slot allocation; or (6) any combination of two or more of (1)-(5).

18. The first UWB device of claim 10, wherein to obtain the first signal transmission schedule the at least one processor is configured to detect a pattern of the first wireless signals that satisfy an interference threshold.

19. A first UWB device (Ultra-Wideband device) comprising:
means for obtaining a first signal transmission schedule of first available signal transmission times of first wireless signals; and
means transmitting, to a second UWB device, a ranging control message indicating a second signal transmission schedule including second available signal transmission times for second wireless signals that comprise UWB signals, wherein the second available signal transmission times are based on the first available signal transmission times.

20. The first UWB device of claim 19, wherein the second available signal transmission times are time division multiplexed with the first available signal transmission times.
